(19) United States
(12) Patent Application Publication
(10) Pub. No.: US 2015/0160838 A1
(43) Pub. Date: Jun. 11, 2015

(54) METHOD AND APPARATUS FOR AUTOMATIC GRAPHIC EDITING WITH MAP-DEPENDENT CONSTRAINTS

(71) Applicant: Takeshi SHIRABE, Solna (SE)

(72) Inventor: Takeshi SHIRABE, Solna (SE)

(21) Appl. No.: 14/099,167

(22) Filed: Dec. 6, 2013

(51) Int. Cl. G06F 3/0484; G06T 11/00; G06T 11/60; G06T 11/20; G06T 3/40

(52) U.S. Cl. CPC G06F 3/04845; G06T 11/203; G06T 3/40; G06T 11/60; G06T 11/001; G06T 2215/16

(57) ABSTRACT

A graphic editing apparatus allows a user to edit graphic objects in a drawing space. The graphic objects are subject to constraints to have specified dimensional properties and/or relationships that need not be Euclidean geometric or topological but may be dependent on spatial variation of selected conditions represented by maps, each of which assigns values to locations in the drawing space. The apparatus also allows the user to edit the constraints. If one or more attributes of a graphic object or of a constraint are modified, then affected graphic objects are selected and modified automatically. If any constraints are violated due to these modifications, the initial and subsequent modifications are undone and information is generated to notify which constraints are violated and how they are violated.

### BACKGROUND

1. Technical Field

Embodiments of the subject matter disclosed herein generally relate to automatic graphic editing of graphic objects in a drawing space. The graphic objects may be subject to map-dependent constraints that need not be Euclidean geometric or topological. The maps assign values to locations in the drawing space. An apparatus performing such editing may be integrated into computer systems that store, process, and/or present spatially-referenced data, such as geographic information systems.

2. Discussion of the Background

Typical computer systems having graphic editing functionality, such as geographic information systems (GIS), allow users to edit graphic objects in a given space referred to herein as a “drawing space,” by specifying their coordinates or by specifying constraints (Euclidian geometric or topological) to which the graphic objects are subject. These systems model at least three types of graphic objects, zero-dimensional, one-dimensional, and two-dimensional objects, which are referred to herein as “point,” “curve,” and “region,” respectively. Typical constraints concern dimensional properties (e.g., length and area), referred to herein as “sizes,” of graphic objects or relationships (e.g., distance and parallelism) between graphic objects. For instance, a GIS may be used to create a line segment by selecting its origin, specifying its length, and associating it with a constraint such that the line segment is parallel to another line segment.

Furthermore, these systems can modify graphic objects automatically, in response to a modification of a graphic object with which they are constrained to have a certain relationship. For example, if one of the aforementioned parallel line segments is rotated, then the other will be rotated automatically so that the two line segments remain parallel to each other.

The process of graphic editing subject to geometric constraints is commonly known as constraint-based or parametric drawing in the context of computer aided design. The conventional methods transform geometric constraints into coordinates that satisfy them, or detect conflicts between the constraints. For these methods to work, it is typically assumed that graphic objects are embedded in an Euclidean space, and that geometric constraints concern only sizes and/or relationships that are defined in terms of Euclidean geometry or topology. For example, the length of a line segment or the distance between two points is supposed to follow the Pythagorean Theorem.

In some situations, analysis and synthesis of graphical objects in a drawing space employs graphic objects having sizes and/or relationships that are not Euclidean geometric or topological but dependent on one or more “maps,” on each of which values are assigned to locations in the drawing space. A map often models spatial variation of a selected condition, such as elevation, vegetation, or population, on or near the surface of the earth. For example, a regional planner may consider the length of a corridor as the integral of an “environmental impact” map along that corridor. As another example, a forest manager may consider the area of a forest as the integral of a “timber productivity” map over that forest.

Conventional computer systems, such as raster-based GIS, can calculate values of selected map-dependent sizes of graphic objects, as well as recalculate those values in response to relocating, reshaping, or resizing the graphic objects. They can also calculate values of selected map-dependent relationships between graphic objects, as well as recalculate those values in response to relocating, reshaping, or resizing the graphic objects. These systems, however, are not designed to do the inverse, that is, to automatically (re)locate, (re)shape, or (re)size graphic objects so that they attain desired values for selected map-dependent sizes and/or relationships. Performing such a task using a conventional system requires (1) setting location, shape, and/or size of graphic objects manually, and (2) directing the system to calculate map-dependent values of selected sizes and/or relationships of the graphic objects to evaluate whether the map-dependent constraints are met, and, if not, to reiterate (1) and (2). In the presence of map-dependent constraints concerning map-dependent sizes and/or relationships, a trial-and-error approach as such can take a prohibitively large amount of time (or simply fail) to realize achieve an arrangement of the graphic objects in the drawing space meeting all the constraints.

Another possible approach is formulating a task of graphic editing with map-dependent constraints as a mathematical problem, e.g. a mixed integer programming problem, and solve it using existing algorithms. Unless it happens to be a special case, however, a problem formulated as such is unlikely to be solvable in a reasonable amount of time. More problematic in this alternative is that a graphic editing task in practice may well involve intangible factors (e.g. aesthetic quality) that do not lend themselves to mathematical formulation but require human creativity.

The ineffectiveness and inefficiency described above also cause another limitation of the conventional methods and systems: while editing a graphic object subject to map-dependent constraints, users of conventional computer systems are not able to estimate whether the changes they make lead to satisfying all the constraints, or how to proceed to achieve a target result (including satisfying all the constraints). When map-dependent constraints need to be taken into account, conventional methods and systems lack the ability to generate such feedback, and, thus, waste users' time, failing to keep the creative process uninterrupted.

### SUMMARY

The above-identified problems and drawbacks of conventional methods and systems are overcome by methods and apparatuses according to various embodiments configured to facilitate editing graphic objects subject to map-dependent constraints. These embodiments may be integrated into computer systems adapted to store and/or process spatially-referenced data such as geographic information systems (GIS). Some embodiments automatically modify graphic objects so that they attain desired values for selected sizes and/or relationships that may be map-dependent. Some embodiments generate feedback information to help users not attempt to modify a graphic object in a manner incompatible with constraints that may be map-dependent.

According to an illustrative embodiment, there is a method for editing an initial representation of graphic objects in a drawing space. The method includes generating the initial representation using (i) one or more maps, in each of which values are assigned to locations in the drawing space, (ii) one or more graphic objects located in the drawing space, and (iii) at least one constraint that is related to at least one graphic object among the one or more graphic objects and is defined based at least one of the one or more maps. The method further includes receiving a user input conducive to altering the initial representation, and automatically generating a new representation of the one or more graphic objects in the drawing space, starting from the initial representation and based on the user input, such that the at least one constraint to be met in the new representation.

According to another illustrative embodiment there is an apparatus configured to enable editing an initial representation of graphic objects in a drawing space. The apparatus has an user interface configured to receive a user input conducive to altering the initial representation, and a data processing unit. The data processing unit is configured to generate the initial representation using (i) one or more maps, in each of which values are assigned to locations in the drawing space, (ii) one or more graphic objects located in the drawing space, and (iii) at least one constraint that is related to at least one graphic object among the one or more graphic objects and is defined based on the one or more maps. The data processing unit is also configured to automatically generate a new representation of the one or more graphic objects in the drawing space, starting from the initial representation and based on the user input, such that any constraint among the at least one constraint to be met in the new representation.

According to yet another illustrative embodiment, a computer readable medium non-transitorily stores executable codes which, when executed on a computer, make the computer perform a method for editing an initial representation of graphic objects in a drawing space. The method includes generating the initial representation using (i) one or more maps, in each of which values are assigned to locations in the drawing space, (ii) one or more graphic objects located in the drawing space, and (iii) at least one constraint that is related to at least one graphic object among the one or more graphic objects and is defined based on the one or more maps. The method further includes receiving a user input conducive to altering the initial representation, and automatically generating a new representation of the one or more graphic objects in the drawing space, starting from the initial representation and based on the user input, such that the at least one constraint to be met in the new representation.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram illustrating an apparatus for graphic editing with map-dependent constraints in accordance with one embodiment;

FIGS. 2A and 2B illustrate raster representations of graphic objects;

FIG. 3 illustrates examples of parent-child and adjacency relationships between graphic objects;

FIGS. 4A, 4B and 4C illustrate embodiments of a graphical user interface (GUI), which associates with a point, a curve, and a region, respectively, the GUI being a window through which a user can get access to one or more attributes of the corresponding graphic object and of constraints related to it;

FIG. 5 illustrates another embodiment of a GUI, which associates with a relationship constraint a window through which a user can get access to one or more attributes of it;

FIG. 6 is a flowchart of a method for creating a new graphic object according to an embodiment;

FIG. 7 is a flowchart illustrating a method for creating a new constraint according to an embodiment;

FIG. 8 is a flowchart illustrating a method for modifying one or more affected graphic objects in response to a user's request to modify a graphic object or a constraint according to an embodiment;

FIG. 9 is a flowchart illustrating a method included for modifying one or more graphic objects affected by an initial modification on a graphic object or a constraint according to an embodiment; and

FIG. 10 is a flowchart of a method for editing an initial representation of graphic objects in a drawing space according to an embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed in the context of modifying an initial representation of graphic objects in a drawing space, such that to satisfy a constraint that is defined based on one or more maps associating values to locations in the drawings space.

Reference throughout the specification to “one embodiment” or “an embodiment” means that a particular feature, structure or characteristic described in connection with an embodiment is included in at least one embodiment of the subject matter disclosed. Thus, the appearance of phrases “in one embodiment” or “in an embodiment” in various places throughout the specification is not necessarily referring to the same embodiment. Further, the particular features, structures or characteristics may be combined in any suitable manner in one or more embodiments.

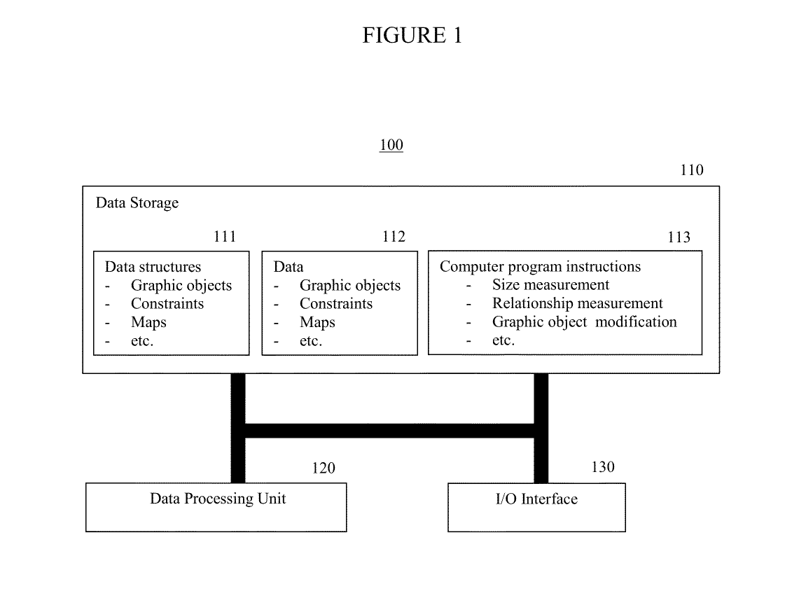

FIG. 1 is a block diagram illustrating an apparatus 100 for graphic editing with map-dependent constraints in accordance with one embodiment. Apparatus 100 comprises a data storage unit 110, a data processing unit 120, and an input/output (IO) interface 130. The data storage unit 110 is configured to store data structures 111, data 112, and computer program instructions 113. The data structures 111 define ways to arrange the data 112, which record data on graphic objects, constraints, maps, etc. The computer program instructions 113 define computational steps to create, modify, update, retrieve, administer, etc., the data 112. The data processing unit 120 is configured to execute the computer program instructions 113. The IO interface 130 is configured to receive input from a user, to display the data to the user, and to provide the data 112 to the data processing unit. The data storage unit 110 may include one or more computer readable media, such as hard disks and optical discs. The data processing unit 120 may use one or more central processing units and random access memories. The IO interface 130 may include one or more IO devices such as a keyboard, a mouse, a stylus pen, a display, and a touchscreen.

The apparatus 100 may share one or more of its components with another apparatus. For example, the apparatus 100 may be integrated in a geographic information system (GIS). Also, the apparatus 100 may distribute its components to a plurality of computers. For example, the data storage unit 110 and the data processing unit 120 may be in one computer, and the IO interface 130 may be in another computer.

### <Map and Graphic Object Data>

One embodiment of the data structures 111 arranges map data and graphic object data in a raster data structure such that a drawing space is discretized into “cells” of the same size, shape, and orientation, and a graph structure is implicitly or explicitly imposed on these cells by connecting each pair of laterally or diagonally adjacent cells with an edge. A map is represented by an array of cells, to each of which a value is assigned. A point is represented by an attribute, “location,” which points to a single cell at which the point is located. The point has another attribute, “state,” which takes the value of either “floating” or “fixed” indicating that the point's location may be set automatically or manually, respectively.

A curve is represented by two attributes, “node list” and “path list,” which point, respectively, to an ordered set of points designated as “nodes” and to an ordered set of “paths,” each of which points to an ordered set of cells connecting two consecutive nodes. Optionally, the curve has two other attributes, “sink,” which points to an end point at which the curve terminates and “sink path,” which points to a path between the end point and last node (i.e., point) in the node list.

A region is represented by two attributes, “center” and “tree,” which point, respectively, to a point which is the region's center and to an acyclic set of paths rooted at the region's center. Alternatively, the tree may be replaced by the set of cells spanned by the acyclic set of paths, if the region's topological structure is not relevant. Optionally, the region has two other attributes, “leaf,” which points to a leaf point at which the longest path terminates, and “center leaf path,” which points to the longest path.

Note that a curve and a region in this embodiment are apparently counterparts of a sequence of line segments and a disk, respectively, in Euclidean geometric terms, but other types of graphic objects may be supported in other embodiments.

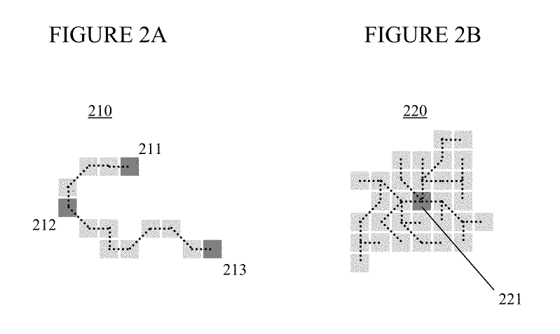

FIG. 2A illustrates a raster representation of points 211, 212, and 213 on a curve 210 represented by a node list containing Points 211, 212, and 213, and a path list containing two paths, one from Point 211 to Point 212 and the other from Point 212 to Point 213.

FIG. 2B illustrates a raster representation of a region 220 represented by a tree rooted at Point 221 to which the region's center is set.

If a point is a node or the sink of a curve or the center or the leaf of a region, then the point is referred to herein as a “child” of the curve or region and the curve or region as a “parent” of the point. One parent may have more than one child, and one child may have more than one parent. If two children are consecutive nodes of a curve, the sink and the last node of a curve, or the center and the leaf of a region, then they are herein said to be “adjacent” or “neighbors” to each other, and more specifically adjacent or neighbors to each other with respect to their common parent. If children of a curve need to be ordered, they are ordered such that the curve's sink is always the last, and the order of other children is as defined by the curve's node list. If children of a region need to be ordered, the region's center is the first and the region's leaf is the last.

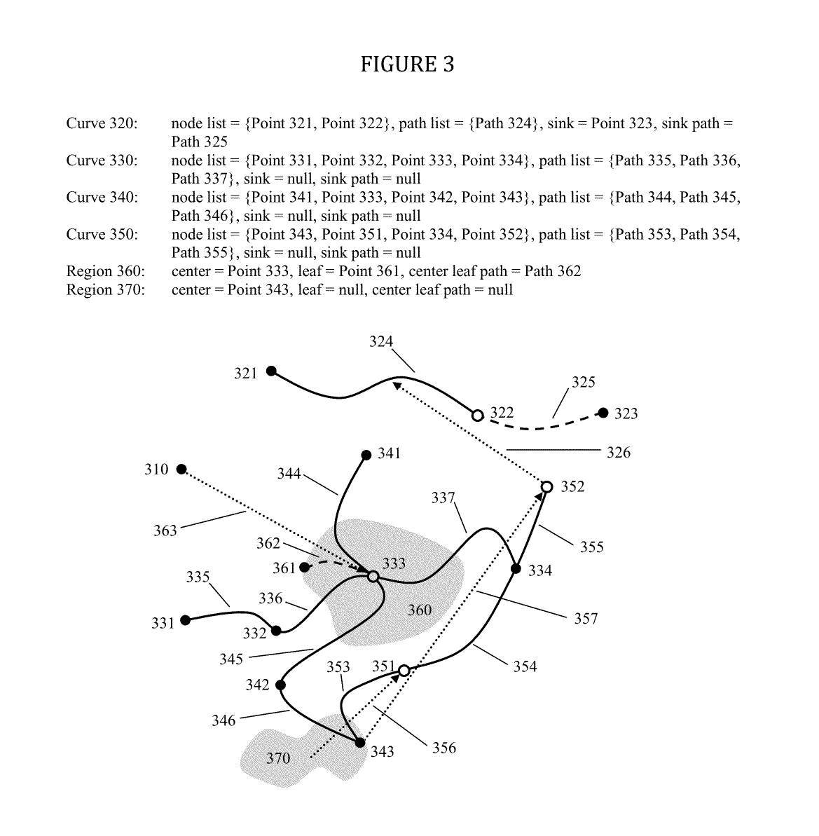

FIG. 3 illustrates examples of parent-child and adjacency relationships between graphic objects. There are 10 fixed points 310, 321, 323, 331, 332, 334, 341, 342, 343, and 361, four floating points 322, 333, 351, and 352, four curves 320, 330, 340, and 350, two regions 360 and 370. Point 310 stands alone; Point 321 is a child of Curve 320; Point 322 is a child of Curve 320; Point 323 is a child of Curve 320; Point 331 is a child of Curve 330; Point 332 is a child of Curve 330; Point 333 is a child of Curve 330, Curve 340, and Region 360; Point 334 is a child of Curve 330 and Curve 350; Point 341 is a child of Curve 340; Point 342 is a child of Curve 340; Point 343 is a child of Curve 340, Curve 350, and Region 370; Point 351 is a child of Curve 350; Point 352 is a child of Curve 350; and Point 361 is a child of Region 360. All points in FIG. 3 except Point 310 have at least one neighbor. Of all, Point 333 has the largest number of neighbors, as it is adjacent to Points 332, 334, 341, 342, and 361. As an example of the order of neighbors, Points 321 and 323 are the preceding and following neighbors of Point 322, respectively, with respect to Curve 320.

There is also a parent-child relationship between a curve and each path of the curve's path list. With reference to FIG. 3, for example, Path 324 is a child of Curve 320, as it is in the curve's path list, and Path 325 is a child of Curve 320, as it is the curve's sink path. As another example, Path 362 is a child of Region 360, as it is the region's center leaf path.

Graphic objects may have sizes that are not Euclidean geometric but dependent on spatial variation of selected conditions represented by maps. A way a size of a graphic object is measured may be specified by one or more attributes of the graphic object, including “size type,” which indicates the type and definition of the size, and “map,” which points to the map used to measure the size. The result of the measurement may be stored in another attribute, “value,” of the graphic object. Examples of size types are “length,” “radius,” and “area.” Given a set map, the length of a curve is measured as the sum of the lengths of all paths in the curve, where the distance between two cells is measured as the minimum of the lengths of all paths between the two cells, where the length of a path is measured as the sum of the weights of all edges in the path, where weights of edges are determined in a way that the weight of an edge connecting two laterally adjacent cells equals to the arithmetic mean of the values of the two cells on the set map and the weight of an edge connecting two diagonally adjacent cells equals to the product of the square root of two and the arithmetic mean of the values of the two cells on the set map. Given a set map, the radius of a region is measured as the maximum distance from the center of the region to any cell of the region, where the distance between two cells is measured as the minimum of the lengths of all paths between the two cells, where the length of a path is measured as the sum of the weights of all edges in the path, where weights of edges are determined in a way that the weight of an edge connecting two laterally adjacent cells equals to the arithmetic mean of the values of the two cells on the set map and the weight of an edge connecting two diagonally adjacent cells equals to the product of the square root of two and the arithmetic mean of the values of the two cells on the set map. Given a set map, the area of a region is measured as the sum of the values, on the set map, of all cells in the region. The abovementioned sizes may be measured in different ways (e.g., according to Tomlin's Map Algebra), which may use more than one map and more than one function.

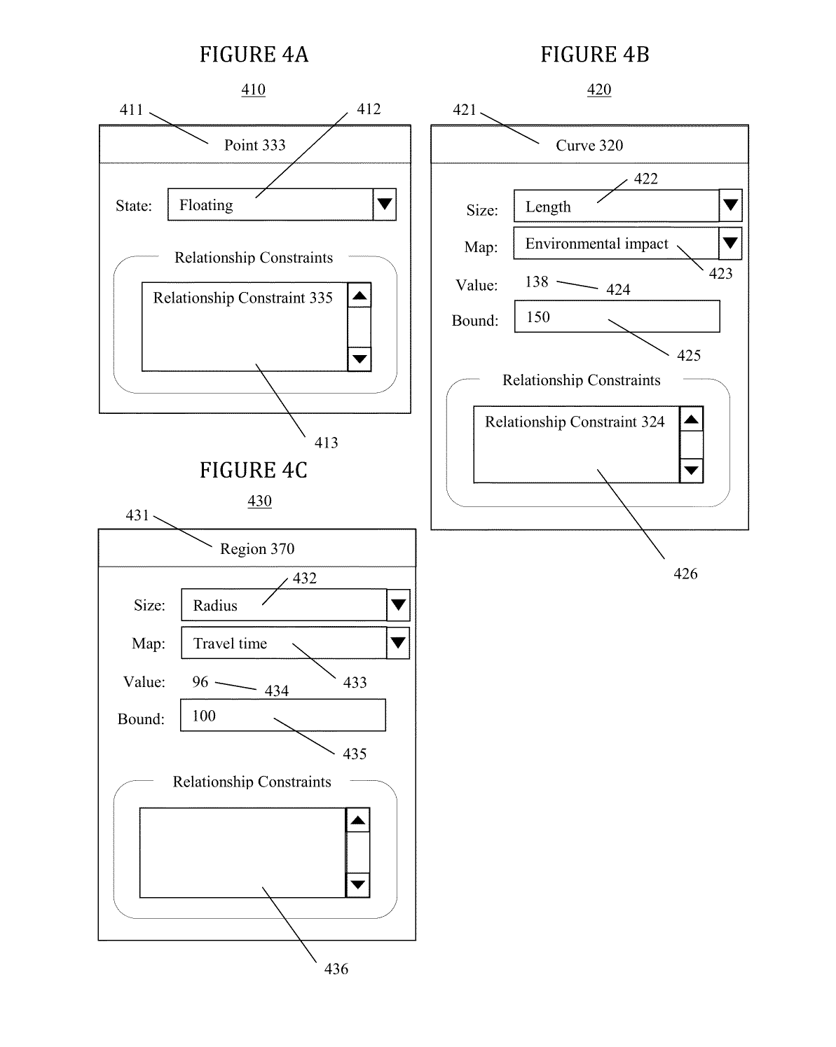

FIGS. 4A-4C illustrates an exemplary GUI, which associates with Point 333, Curve 320, and Region 370 a window 410, a window 420, and a window 430, respectively, through which a user can get access to one or more attributes of the corresponding graphic object. In this GUI, it is assumed that one and only one size may be defined for a graphic object and that none or one map may be used to measure the size. Window 410 contains a title bar 411, which reads “Point 333” in the present example, indicating the graphic object type and ID of the corresponding point, and Drop-down list 412 indicating the state of the point, which is “Floating” in the present example. Window 420 contains a title bar 421, which reads “Curve 320” in the present example, indicating the graphic object type and ID of the corresponding curve, Drop-down list 422 containing one or more size types, from which “Length” is selected in the present example, that may be associated with the curve, Drop-down list 423 containing one or more maps, from which a map of “Environmental impact” is selected in the present example, that may be used to measure the curve's length, and a label 424, which reads “138” in the present example, indicating the value of the curve's length in terms of the Environmental impact” map. Note that if no map is selected in Drop-down list 423, Curve 320's map is automatically set to a map that represents no-value-assigned Euclidean space. Window 430 contains a title bar 431, which reads “Region 370” in the present example, indicating the graphic object type and ID of the corresponding region, Drop-down list 432 containing one or more size types, from which “Radius” is selected in the present example, that may be associated with the region, Drop-down list 433 containing one or more maps, from which a map of “Travel time” is selected in the present example, that may be used to measure the region's radius, and a label 434, which reads “96” in the present example, indicating the value of the region's radius in terms of the “Travel time” map. Note that if no map is selected in Drop-down list 433, Region 370's map is automatically set to a map that represents no-value-assigned Euclidean space.

Graphic objects may have relationships that are not Euclidean geometric or topological but dependent on spatial variation of selected conditions represented by maps. A way a relationship of a first graphic object with a second graphic object is measured is specified by one or more attributes of the first graphic object, including “graphic object”, which points to the second graphic object, “relationship type,” which indicates the type and definition of the relationship, and “map,” which points to the map used to measure the relationship. Examples of relationship types are “containment,” “distance,” “visibility,” and “flow direction.” The containment of a first graphic object by a second graphic object is measured in binary terms; that is, true if all cells of the first graphic object are cells of the second graphic object or false otherwise. Given a set map, the distance of a first graphic object to a second graphic object is measured as the minimum of the distances between any cell of the first graphic object and any cell of the second graphic object, where the distance between two cells is measured as the minimum of the lengths of all paths between the two cells, and the length of a path is measured as the sum of the weights of all edges in the path, where weights of edges are determined in a way that the weight of an edge connecting two laterally adjacent cells equals to the arithmetic mean of the values of the two cells on the set map and the weight of an edge connecting two diagonally adjacent cells equals to the product of the square root of two and the arithmetic mean of the values of the two cells on the set map. Given a set map on which the value of each cell is regarded as the height of that cell, the visibility of a first graphic object from a second graphic object is measured in binary terms; that is, true if the straight line of any cell of the first graphic object to some cell of the second graphic object does not intersect any other cell or as false otherwise. Given a set map, the flow direction to a first graphic object from a second graphic object is measured in ternary terms; that is, down if any cell of the first graphic object can be reached from some cell of the second graphic object through a sequence of cells such that each cell is followed by one of its adjacent cells having the steepest decrease in value on the set map, up if from any cell of the first graphic object some cell of the second graphic object can be reached through a sequence of cells such that each cell is followed by one of its adjacent cells having the steepest decrease in value on the set map, or neither up or down otherwise. The abovementioned relationships may be measured in different ways (e.g., according to Tomlin's Map Algebra), which may use more than one map and more than one function.

### <Constraint Data>

In accordance with one embodiment of the data structures 111, there are two types of constraints: size constraint and relationship constraint. A size constraint is specified by one or more attributes including “constrained graphic object,” which points to the graphic object it constrains, “size type,” which indicates the type and definition of the constrained graphic object's size, and “map,” which points to the map used to measure the size, and “bound,” which indicates the value by which the specified size is bounded (from above and/or below depending on the size type and/or according to the user's choice). These attributes may be accessed through a GUI control associated with the constrained graphic object.

An example of GUI associated to a point (i.e., Point 333) is Window 410 illustrated in FIG. 4A. An example of GUI associated with a curve (i.e., Curve 320) is window 420 in FIG. 4B. An example of GUI associated with a region (i.e., Region 370) is window 430 in FIG. 4C.

A graphic object may be constrained by none or one size constraint and that none or one map may be used to measure the graphic object's size. Window 420 indicates that a size constraint sets an upper bound on the length of the curve in term of the “Environmental impact” map to 150, as its size type is set to length in Drop-down list 422, its map set to the “Environmental impact” map in Drop-down list 423, and its bound set to 150 in a text box 425. Note that if no map is selected in Drop-down list 423, the size constraint's map is automatically set to a map that represents no-value-assigned Euclidean space.

A relationship constraint is specified by one or more attributes including “constrained graphic object,” which points to the graphic object it constrains, “constraining graphic object,” which points to the graphic object the constrained graphic object constrains to, “relationship type,” which indicates the type and definition of the relationship of the first graphic object with the second graphic object, “map,” which points to the map used to measure the specified relationship, and “bound,” which indicates the value by which the specified relationship is bounded (from above and/or below depending on the size type and/or according to the user's choice). These attributes may be accessed through a GUI control.

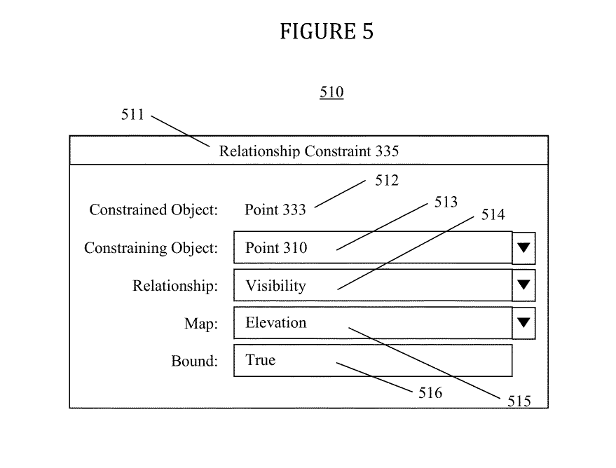

In view of the above explanations, Window 410 has a list box 413 containing relationship constraints related to the Point 333, Window 420 has a list box 426 containing relationship constraints related to the Curve 320, and Window 430 has a list box 436 containing relationship constraints related to the Region 370. If a user selects item “Relationship Constraint 363” in List box 413 (e.g., by double-clicking), a window 510 illustrated in FIG. 5 appears, which enables a user to get access to one or more attributes of Relationship constraint 363. Window 510 contains a title bar 511, which reads “Relationship Constraint 363” in the present example, indicating the constraint type and ID of the corresponding constraint, a label 512, which reads “Point 333” in the present example, indicating its constrained graphic object, Drop-down list 513 containing one or more graphic objects, from which “Point 310” is selected in the present example, to which the constrained graphic object may be constrained, Drop-down list 514 containing one or more relationship types, from which “Visibility” is selected in the present example, that may be associated with the constrained graphic object, Drop-down list 515 containing maps, from which a map of “Elevation” is selected in the present example, that may be used to measure the visibility of the constrained graphic object from the constraining graphic object, and a text box 516, which reads “True” in the present example, indicating the presence of visibility of Point 333 from Point 310 in terms of the “Elevation” map. With these settings, Relationship constraint 363 constraints Point 333 to be visible from Point 310 over the terrain inferred by the “Elevation” map. Note that if no map is selected in Drop-down lists 515, Relationship Constraint 363's map is automatically set to a map that represents no-value-assigned Euclidean space. FIG. 3 illustrates with dotted arrows three other relationship constraints: Relationship Constraint 356, whose constrained object and constraining object are Point 351 and Region 370, respectively; Relationship Constraint 357, whose constrained object and constraining object are Point 352 and Point 343, respectively; Relationship Constraint 326, whose constrained object and constraining object are Curve 320 and Point 352, respectively. Note that a relationship constraint constraining a curve or region implicitly constrains all of its children in the same way.

Each relationship constraint has its “feasible space,” that is, a subset of the drawing space outside of which its constrained graphic object may not be located. Each graphic object has its “feasible space,” too, which is, if it is constrained by one or more relationship constraints, the intersection of the feasible spaces of all the relationship constraints, or the entire drawing space, otherwise. In one embodiment of the present invention, if a constraint or its constraining graphic object is modified, the feasible space of its constrained graphic object is automatically modified.

Note that whichever it is of size or relationship type, a constraint may be disregarded if it is not completely specified, for example:
if its size type or relationship type is set to null,
if its bound is set to an undefined value, or
if its constrained graphic object or constraining graphic object is set to null, to a point whose location is set to null, to a curve whose node list is empty, or to a region whose tree is empty.

### <Creation of Graphic Objects and Constraints>

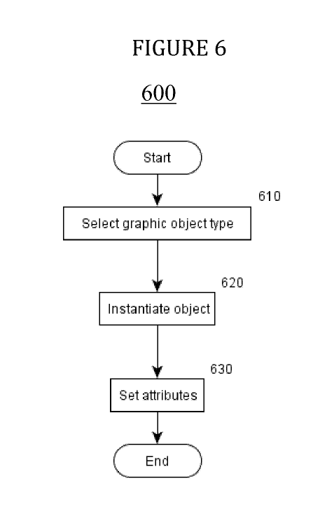

FIG. 6 is a flowchart illustrating a method 600 included in one embodiment of the computer program instructions 113 for creating a new graphic object. At Step 610, according to a user's request, a graphic object type for a new graphic object is selected. At Step 620, a graphic object is instantiated from the selected graphic object type. At Step 630, the graphic object's ID is set to an automatically generated unique identifier, some of its other attributes are set to preset default values, and its feasible space is set to the set of all cells in the drawing space.

Method 600 may be called through a GUI control such as a menu containing a list of graphic object types, from which one is to be selected. Alternatively, it, possibly together with other methods, may be called in response to a certain event with a pointing device. As an example, while a curve is being edited, if a user right-clicks on a cell and selects a menu item labeled “Node” from a pop-up menu that has popped up, then a request is made for creating a new point and setting its location's to that cell and its state to fixed, and adding it to the curve's node list. As another example, while a curve is being edited, if a user right-clicks on a cell and selects a menu item labeled “Sink” from a pop-up menu that has popped up, then a request is made for creating a new point and setting its location to that cell and its state to fixed, and setting the curve's sink to the new point. As yet another example, while a region is being edited, if a user right-clicks on a cell and selects a menu item labeled “Center” from a pop-up menu that has popped up, then a request is made for creating a new point and setting its location to that cell and its state to fixed, and setting the region's center to the new point. As yet another example, while a region is being edited, if a user right-clicks on a cell and selects a menu item labeled “Leaf” from a pop-up menu that has popped up, then a request is made for creating a new point, setting its location to that cell and its state to fixed, and setting the region's leaf to the new point.

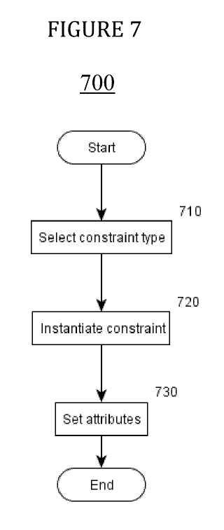

FIG. 7 is a flowchart illustrating a method 700 included in one embodiment of the computer program instructions 113 for creating a new constraint. At Step 710, according to a user's request, a constraint type for a new constraint is selected. At Step 720, a constraint is instantiated from the selected constraint type. At Step 730, the constraint's ID is set to an automatically generated unique identifier, and some of its other attributes are set to preset default values.

Method 700 may be called through a GUI control such as a menu containing a list of constraint types, from which one is to be selected. Alternatively, it may be called, possibly together with other methods, in response to a certain gesture with a pointing device. For example, while a first graphic object is being edited, if a user right-clicks inside a second graphic object and selects a menu item labeled “Contained by” from a pop-up menu that has popped up, then a request is made for creating a new relationship constraint and setting its constrained graphic object to the first graphic object, its constraining graphic object to the second graphic, its relationship type to “containment,” and its bound to “True.”

### <Manual Modification of Graphic Objects and Constraints>

Through the I/O means 130, a user may (re)set one or more attributes of a graphic object or delete a graphic object at the user's discretion.

A request for setting an attribute of a graphic object may be made through a GUI control such as Window 410, 420, or 430 (in FIG. 4) associated with Point 333, Curve 320, or Region 370 (in FIG. 3), respectively. A request for setting Point 333's state may be made by selecting either “Fixed” or “Floating” (as in the present example) from Drop-down list 412. A request for setting Curve 320's size type may be made by selecting a size type (“Length” in the present example) from Drop-down list 422. A request for setting Curve 320's map may be made by selecting a map (a map of “Environmental impact” in the present example) from Drop-down list 423. A request for setting Region 370's size type may be made by selecting a size type (“Radius” in the present example) from Drop-down list 432. A request for setting Region 370's map may be made by selecting a map (“Travel time” map in the present example) from Drop-down list 433.

A request for setting the location of a point to a cell may be made using a pointing device such as a mouse. For example, while a point is being edited, if a user grabs it and drags it to a cell (or clicks on a cell if the point's location is currently set to null), a request is made for setting the point's location to the cell. To prevent a user from making a request for setting the location of a point to an infeasible cell, its feasible space may be highlighted in the drawing space.

A request for adding a point to the node list of a curve may be made using a pointing device. For example, while a curve is being edited, if a user right-clicks on a point and selects a menu item labeled “Node” from a pop-up menu that has popped up, then a request is made for adding the point to the curve's node list.

A request for removing a point from the node list of a curve may be made using a pointing device. For example, while a curve is being edited, if a user right-clicks on a point that is contained in the curve's node list and selects a menu item labeled “Remove” from a pop-up menu that has popped up, then a request is made for removing it from the curve's node list.

A request for setting the sink of a curve may be made using a pointing device. For example, while a curve is being edited, if a user right-clicks on a point and selects a menu item labeled “Sink” from a pop-up menu that has popped up, then a request is made for setting the curve's sink to the point.

A request for setting the sink of a curve to null may be made using a pointing device. For example, while a curve is being edited, if a user right-clicks on a point to which the curve's sink or center is set and selects a menu item labeled “Nullify” from a pop-up menu that has popped up, then a request is made for setting the curve's sink to null.

A request for setting the center or leaf of a region may be made using a pointing device. For example, while a region is being edited, if a user right-clicks on a point and selects a menu item labeled “Center” or “Leaf” from a pop-up menu that has popped up, then a request is made for setting the region's center or leaf, respectively, to the point.

A request for setting the center or leaf of a region to null may be made using a pointing device. For example, while a region is being edited, if a user right-clicks on a point to which the region's center or leaf is set and selects a menu item labeled “Nullify” from a pop-up menu that has popped up, then a request is made for setting the region's center or leaf to null.

A request for deleting a graphic object may be made using a pointing device. For example, while a graphic object is being edited, if a user grabs it and presses the delete key on a keyboard, then a request is made for deleting it.

Using the I/O interface 130, a user may (re)set one or more attributes of a constraint or delete a constraint at the user's discretion.

A request for setting an attribute of a size constraint may be made through a GUI, such as Window 420 (in FIG. 4B) associated with Curve 320 (in FIG. 3) which is constrained by a size constraint. A request for setting the constraint's size type may be made by selecting a size type (“Length” in the present example) from Drop-down list 422. A request for setting its map may be made by selecting a map (“Environmental impact” map in the present example) from Drop-down list 423. A request for setting its bound may be made by typing a value (150 in the present example) in Text box 425.

A request for setting an attribute of a relationship constraint may be made through a GUI control, such as Window 510 (in FIG. 5) associated with Relationship Constraint 363 constraining Point 333 (in FIG. 3). A request for setting the constraint's constraining graphic object may be made by selecting a graphic object (Point 310 in the present example) from Drop-down list 513. A request for setting its relationship type may be made by selecting a relationship type (“Visibility” in the present example) from Drop-down list 514. A request for setting its map may be made by selecting a map (“Elevation” map in the present example) from Drop-down list 515. A request for setting its bound may be made by typing a value (True in the present example) in Text box 516.

A request for deleting a constraint may be made through a GUI control. With reference to FIG. 4, for example, if a user selects an item labeled “Relationship Constraint 363” from List box 413 on Window 410 and presses the delete key on a keyboard, then a request is made for deleting the corresponding constraint.

### <Automatic Modification of Graphic Objects>

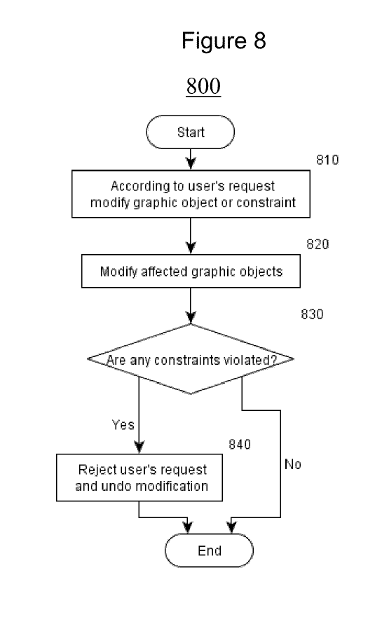

FIG. 8 is a flowchart illustrating a method 800 included in one embodiment of the computer program instructions 113 for, in response to a user's request to modify a graphic object or a constraint, modifying one or more affected graphic objects.

At Step 810, a user's request is made for modifying a graphic object or a constraint by deleting it or (re)setting an attribute of it.

In one embodiment of the present invention, one or more rules may be enforced to prevent a user from requesting a modification that immediately causes at least one constraint to be violated. For example, a request for setting the location of a curve to a cell outside the point's feasible space is rejected. As another example, a request for adding to the list of a curve a point whose location is set to a cell outside the curve's feasible space is rejected.

As yet another example, a request for setting an attribute of a constraint is rejected, if it causes the feasible space of a graphic object to be empty. As yet another example, a request for setting an attribute of a constraint is rejected, if it causes the feasible space of a curve or region not to have any non-empty, connected subset intersecting the feasible space of every child of the curve or region.

In one embodiment of the present invention, one or more rules may be enforced to prevent a user from requesting a modification that may lead to a significant amount of computation. For example, a request is rejected, if it causes more than a specified number of floating points to be connected. With reference to FIG. 3, if the specified number is one, a request for setting Point 334's state to floating is rejected, because it would cause Points 334, 333, 351, and 352 to be connected. As another example, a request is rejected, if it causes a graphic object to be constrained to itself through a cycle of more than a specified number of constraints. With reference to FIG. 3, if the specified number is one, a request for making a new constraint constraining Point 352 to Curve 320 is rejected, because Curve 320 is already constrained to Point 352.

If none of the preset rules such as those described above is violated, then the user's request is accepted and the requested modification is made. Some automatic modifications may immediately follow to maintain preset data consistency conditions, such as:
if the node list of a curve contains at least two points, there is a path at the kth position in the curve's path list, starting at a first point at the kth position in the curve's node list, and ending at a second point at the (k+1)th position in the curve's node list,
if the node list of a curve contains none or one point, the curve's path list is empty,
if the node list of a curve is empty, the curve's sink path is set to null,
if the sink of a curve is set to null, the curve's sink path is set to null,
it the node list of a curve is empty and its sink is set to null, the curve's value is set to a default value, which is typically 0,
if either the center or leaf of a region is set to null, the region's center leaf path is set to null, and
if both the center and leaf of a region are set to null, the region's value is set to a default value, which is typically 0.

At Step 820, all graphic objects affected by the requested modification are selected and modified by a preset method, and their attributes are updated accordingly.

At Step 830, a check is made whether any constraints are violated. If not, the modification was successful and the method ends. Otherwise, Step 840 follows, and the user's initial request is rejected, all the modification it caused directly or indirectly is undone, and information is generated informing which graphic objects violate which constraints and how they do.

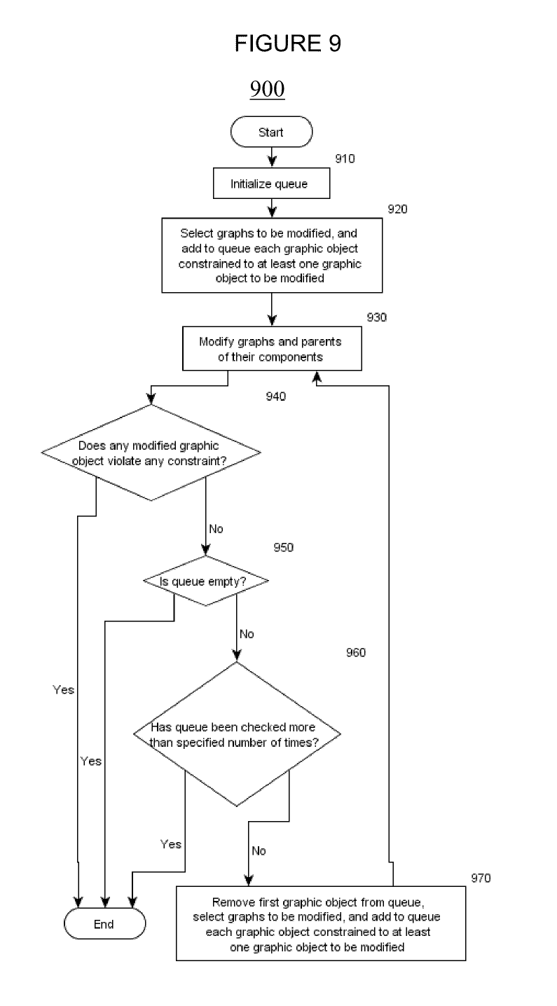

FIG. 9 is a flowchart illustrating a method 900 included in one embodiment of the computer program instructions 113, which may be used at Step 820 of Method 800, for modifying one or more graphic objects affected by an initial modification on a graphic object or on a constraint. It does so by iteratively selecting and modifying connected graphs of points and paths that are components of the affected graphic objects. In another embodiment, Method 900 is replaced by another method available at the time of implementation.

At Step 910, an empty graphic object queue S of graphic objects is created, and an empty graph set T of graphs is created. If the initial modification was made on a constraint, its constrained graphic object is added to Graphic object queue S.

At Step 920, the following operations are performed:
first
   if the state of a point P was set to floating in the initial modification, creating a graph G consisting of an empty point set N and an empty path set A, adding Point P to Point set N, adding Graph G to Graph set T, and adding to Graphic object queue S each graphic object constrained to Point P if it is not contained by the queue,
   if the location of a point P was set in the initial modification,
      for each path K, of each graphic object O, that is incident to Point P and a fixed point Q, creating a graph G consisting of an empty point set N and an empty path set A, adding Points P and Q to Point set N, adding Path K to Path set A, adding Graph G to Graph set T, and adding to Graphic object queue S each graphic object constrained to Point P or Graphic object O, if it is not contained by the queue,
      for each path K′, of each graphic object O′, that is incident to Point P and a floating point Q′, creating a graph G′ consisting of an empty point set N′ and an empty path set A′, adding Point Q′ to Point set N′, adding Graph G′ to Graph set T, and adding to Graphic object queue S each graphic object constrained to Point P, Point Q′, or Graphic object O′, if it is not contained by the queue,
      for each graphic object O″ such that Point P is its only child, creating a graph G″ consisting of an empty point set N″ and an empty path set A″, adding Point P to Point set N, adding Graph G″ to Graph set T, and adding to Graphic object queue S each graphic object constrained to Point P or Graphic object O″, if it is not contained by the queue,
   if a point P was deleted in the initial modification,
      for each two consecutive paths K and L, of each graphic object O, that were deleted as a consequence of the deletion of Point P and were, before their deletion, incident, respectively, to a fixed point Q and Point P and to Point P and a fixed point R, creating a graph G consisting of an empty point set N and an empty path set A, adding Points Q and R to Point set N, adding to Path set A the path, of Graphic object O, that replaced Paths K and L as a consequence of the deletion of Point P, adding Graph G to Graph set T, and adding to Graphic object queue S each graphic object constrained to Point P or Graphic object O, if it is not contained by the queue,
      for each path K′, of each graphic object O′, that was deleted as a consequence of the deletion of Point P and was, before its deletion, incident to Point P and a floating point Q′, creating a graph G′ consisting of an empty point set N′ and an empty path set A′, adding Point Q′ to Point set N′, adding Graph G′ to Graph set T, and adding to Graphic object queue S each graphic object constrained to Point P, Point Q′, or Graphic object O′, if it is not contained by the queue,
      for each path K″, of each graphic object O″ having Point P as its last or first child, that was deleted as a consequence of the deletion of Point P and was, before its deletion, incident to Point P and a fixed point Q″, creating a graph G″ consisting of an empty point set N″ and an empty path set A″, adding Point Q″ to Point set N″, adding Graph G″ to Graph set T, and adding to Graphic object queue S each graphic object constrained to Point P or Graphic object O″, if it is not contained by the queue,
      for each graphic object O′″ such that Point P was its only child before the deletion of Point P, adding to Graphic object queue S each graphic object constrained to Point P or Graphic object O′″, if it is not contained by the queue,
   if a fixed point P was added to the node list of a curve C or if Curve C's sink was set to Point P, in the initial modification,
      for each path K, of Curve C, that is incident to Point P and a fixed point Q, creating a graph G consisting of an empty point set N and an empty path set A, adding Points P and Q to Point set N, adding Path K to Path set A, adding Graph G to Graph set T, and adding to Graphic object queue S each graphic object constrained to Curve C, if it is not contained by the queue,
      for each path K, of Curve C, that is incident to Point P and a floating point Q′, creating a graph G′ consisting of an empty point set N′ and an empty path set A′, adding Point Q′ to Point set N′, adding Graph G′ to Graph set T, and adding to Graphic object queue S each graphic object constrained to Point Q′ or Curve C, if it is not contained by the queue,
      if Point P is Curve C's only child, creating a graph G″ consisting of an empty point set N″ and an empty path set A″, adding Point P to Point set N″, adding Graph G″ to Graph set T, and adding to Graphic object queue S each graphic object constrained to Curve C, if it is not contained by the queue,
   if a floating point P was added to the node list of a curve C or Curve C's sink was set to Point P in the initial modification, creating a graph G consisting of an empty point set N and an empty path set A, adding Point P to Point set N, adding Graph G to Graph set T, and adding to Graphic object queue S each graphic object constrained to Point P or Curve C, if it is not contained by the queue,
   if a point P was removed from the node list of a curve C or if Point P had been Curve C's sink but Curve C's sink was set to null, in the initial modification,
      for each two consecutive paths K and L, of Curve C, that were deleted as a consequence of the removal of Point P and were, before their deletion, incident, respectively, to a fixed point Q and Point P and to Point P and a fixed point R, creating a graph G consisting of an empty point set N and an empty path set A, adding Points Q and R to Point set N, adding to Path set A the path, of Curve C, that replaced Paths K and L as a consequence of the removal of Point P, adding Graph G to Graph set T, and adding to Graphic object queue S each graphic object constrained to Curve C, if it is not contained by the queue,
      for each path K′, of Curve C, that was deleted as a consequence of the removal of Point P and was, before its deletion, incident to Point P and a floating point Q′, creating a graph G′ consisting of an empty point set N′ and an empty path set A′, adding Point Q′ to Point set N′, adding Graph G′ to Graph set T, and adding to Graphic object queue S each graphic object constrained to Point Q′ or Curve C, if it is not contained by the queue
      if Point P was the last or first child of Curve C, for each path K″, of Curve C, that was deleted as a consequence of the removal of Point P and was, before its deletion, incident to Point P and a fixed point Q″, creating a graph G″ consisting of an empty point set N″ and an empty path set A″, adding Point Q″ to Point set N″, adding Graph G″ to Graph set T, and adding to Graphic object queue S each graphic object constrained to Curve C, if it is not contained by the queue,
      if Point P was Curve C's only child before its removal, adding to Graphic object queue S each graphic object constrained to Curve C, if it is not contained by the queue,
      if Point P was a floating point, creating a graph G′″ consisting of an empty point set N′″ and an empty path set A′″, adding Point P to Point set N′″, adding Graph G′″ to Graph set T, and adding to Graphic object queue S each graphic object constrained to Point P, if it is not contained by the queue,
   if the size type or map of a curve C was set in the initial modification,
      for each path K, of Curve C, that is incident to fixed points P and Q, creating a graph G consisting of an empty point set N and an empty path set A, adding Points P and Q to Point set N, adding Path K to Path set A, adding Graph G to Graph set T, and adding to Graphic object queue S each graphic object constrained to Curve C, if it is not contained by the queue,
      for each floating point P′ of Curve C, creating a graph G′ consisting of an empty point set N′ and an empty path set A′, adding Point P′ to Point set N′, adding Graph G′ to Graph set T, and adding to Graphic object queue S each graphic object constrained to Point P′ or Curve C, if it is not contained by the queue,
   if a child of a region R was set to a fixed point P in the initial modification,
      if Region R's other child is set to null, creating a graph G consisting of an empty point set N and an empty path set A, adding Point P to Point set N, adding Graph G to Graph set T, and adding to Graphic object queue S each graphic object constrained to Region R, if it is not contained by the queue,
      if Region R's other child is set to a fixed point, creating a graph G′ consisting of an empty point set N′ and an empty path set A′, adding to Point set N′ the point to which Region R's center is set, adding Graph G′ to Graph set T, and adding to Graphic object queue S each graphic object constrained to Region R, if it is not contained by the queue,
      Region R's other child is set to a floating point Q″, creating a graph G″ consisting of an empty point set N″ and an empty path set A″, adding Point Q″ to Point set N″, adding Graph G″ to Graph set T, and adding to Graphic object queue S each graphic object constrained to Point Q″ or Region R, if it is not contained by the queue,
   if a child of a region R was set to a floating point P in the initial modification, creating a graph G consisting of an empty point set N and an empty path set A, adding Point P to Point set N, adding Graph G to Graph set T, and adding to Graphic object queue S each graphic object constrained to Point P or Region R, if it is not contained by the queue,
   if a child of a region R, which had been set to a point P, was set to null in the initial modification,
      if Region R's other child is set to null, adding to Graphic object queue S each graphic object constrained to Region R, if it is not contained by the queue,
      if Region R's other child is set to a fixed point Q, creating a graph G consisting of an empty point set N and an empty path set A, adding Point Q to Point set N, adding Graph G to Graph set T, and adding to Graphic object queue S each graphic object constrained to Region R, if it is not contained by the queue,
      if Region R's other child is set to a floating point Q′, creating a graph G′ consisting of an empty point set N′ and an empty path set A′, adding Point Q′ to Point set N, adding Graph G′ to Graph set T, and adding to Graphic object queue S each graphic object constrained to Point Q′ or Region R, if it is not contained by the queue,
      if Point P was a floating point, creating a graph G″ consisting of an empty point set N″ and an empty path set A″, adding Point P to Point set N′, adding Graph G″ to Graph set T, and adding to Graphic object queue S each graphic object constrained to Point P or Region R, if it is not contained by the queue,
   if the size type or map of a region R was set in the initial modification,
      if one of Region R's children is set to null and the other to a fixed point P, creating a graph G consisting of an empty point set N and an empty path set A, adding Point P to Point set N, adding Graph G to Graph set T, and adding to Graphic object queue S each graphic object constrained to Region R, if it is not contained by the queue,
      if one of Region R's children is set to null and the other to a floating point P′, creating a graph G′ consisting of an empty point set N′ and an empty path set A′, adding Point P′ to Point set N′, adding Graph G′ to Graph set T, and adding to Graphic object queue S each graphic object constrained to Point P′ or Region R, if it is not contained by the queue,
      if both of Region R's children are set to fixed points, creating a graph G″ consisting of an empty point set N″ and an empty path set A″, adding to Point set N″ the point to which Region R's center is set, adding Graph G″ to Graph set T, and adding to Graphic object queue S each graphic object constrained to Region R, if it is not contained by the queue,
      if neither of Region R's children is set to null and at least one of Region R's children is set to a floating point P′″, creating a graph G′″ consisting of an empty point set N′″ and an empty path set A′″, adding Point P′″ to Point set N′″, adding Graph G′″ to Graph set T, and adding to Graphic object queue S each graphic object constrained to Point P″ or Region R, if it is not contained by the queue,
   if a graphic object O, which was a curve or region, was deleted in the initial modification, for each floating point P of Graphic object O, creating a graph G consisting of an empty point set N and an empty path set A, adding Point P to Point set N, adding Graph G to Graph set T, and adding to Graphic object queue S each graphic object constrained to Point P or Graphic object O, if it is not contained by the queue,
then, for each graph in Graph set T, adding to the graph's point set all floating points connected, through a sequence of floating points in the graph's point set, to at least one floating point in the graph's point set, adding to the graph's path set all paths between any two adjacent floating points in the graph's point set, and adding to Graphic object queue S each graphic object constrained to at least one of the added floating points or one of its parents, if it is not contained by the queue,
then, for each graph in Graph set T, adding to the graph's point set all fixed points adjacent to at least one floating point in the graph's point set, adding to the graph's path set all paths between any fixed point and any floating point, in the graph's point set, that are adjacent to each other, and adding, to Graphic object queue S, each graphic object constrained to at least one parent of at least one of the added paths, if it is not contained by the queue, and
then, recursively deleting one of each two identical graphs in Graph set T and merging each two graphs, in Graph set T, having at least one common floating point into one until there are no such graphs.

At Step 930, for each graph in Graph set T,
its floating points are relocated within their feasible spaces and its paths are modified within the feasible spaces of their parent graphic objects so that the sum of the sizes of all the paths, where the size of each path is measured in the way specified by the attributes of its parent graphic object, is minimized,
for each region whose center is set to a point in the graph, the region's tree is rebuilt within the region's feasible area so that the region's size does not exceed the region's bound and, if the region's leaf is not set to null, the path from the region's center to the region's leaf is the longest of all paths in the region's tree, where the length of each path is measured in the way specified by the attributes of the region,
for each region whose center is set to null and leaf is set to a point in the graph, the region's tree is emptied, and
the attributes of each modified graphic object are updated.

At Step 940, a check is made whether any modified graphic object violates any constraint constraining it. If so, information is generated informing that some constraints are not satisfied and the method ends. Otherwise, Step 950 follows.

At Step 950, a check is made whether Graphic object queue S is empty. If so, information is generated informing that all the constraints are satisfied and the method ends. Otherwise, Step 960 follows.

At Step 960, a check is made whether Step 950 has been repeated more than a specified number of times. If so, the method ends. Otherwise, Step 970 follows.

At Step 970, the first graphic object O is removed from Graphic object queue S, Graph set T is emptied, and the following operations are performed:
first
   if Graphic object O is a point, creating a graph G consisting of an empty point set N and an empty path set A, adding Graphic object O to Point set N, adding Graph G to Graph set T, and adding to Graphic object queue S each graphic object constrained to Graphic object O, if it is not contained by the queue,
   if Graphic object O is a curve,
      for each path K, of Graphic object O, that is incident to fixed points P and Q, creating a graph G consisting of an empty point set N and an empty path set A, adding Points P and Q to Point set N, adding Path K to Path set A, adding Graph G to Graph set T, and adding to Graphic object queue S each graphic object constrained to Graphic object O, if it is not contained by the queue,
      for each floating point P′ of Graphic object O, creating a graph G′ consisting of an empty point set N′ and an empty path set A′, adding Point P′ to Point set N′, adding Graph G′ to Graph set T, and adding to Graphic object queue S each graphic object constrained to Point P′ or Graphic object O, if it is not contained by the queue,
   if Graphic object O is region,
      if one of Graphic object O's children is set to null and the other to a fixed point P, creating a graph G consisting of an empty point set N and an empty path set A, adding Point P to Point set N, adding Graph G to Graph set T, and adding to Graphic object queue S each graphic object constrained to Graphic object O, if it is not contained by the queue,
      if one of Graphic object O's children is set to null and the other to a floating point P′, creating a graph G′ consisting of an empty point set N′ and an empty path set A′, adding Point P′ to Point set N′, adding Graph G′ to Graph set T, and adding to Graphic object queue S each graphic object constrained to Point P′ or Graphic object O, if it is not contained by the queue,
      if both of Graphic object O's children are set to fixed points, creating a graph G″ consisting of an empty point set N″ and an empty path set A″, adding to Point set N″ the point to which Region R's center is set, adding Graph G″ to Graph set T, and adding to Graphic object queue S each graphic object constrained to Graphic object O, if it is not contained by the queue,
      if neither of Graphic object O's children is set to null and at least one of Graphic object O's children is set to a floating point P′″, creating a graph G′″ consisting of an empty point set N′″ and an empty path set A′″, adding Point P′″ to Point set N′″, adding Graph G′″ to Graph set T, and adding to Graphic object queue S each graphic object constrained to Point P′″ or Region R, if it is not contained by the queue,
then, for each graph in Graph set T, adding to the graph's point set all floating points connected, through a sequence of floating points in the graph's point set, to at least one floating point in the graph's point set, adding to the graph's path set all paths between any two adjacent floating points in the graph's point set, and adding to Graphic object queue S each graphic object constrained to at least one of the added floating points or one of its parents, if it is not contained by the queue,
then, for each graph in Graph set T, adding to the graph's point set all fixed points adjacent to at least one floating point in the graph's point set, adding to the graph's path set all paths between any fixed point and any floating point, in the graph's point set, that are adjacent to each other, and adding, to Graphic object queue S, each graphic object constrained to at least one parent of at least one of the added paths, if it is not contained by the queue, and
then, recursively deleting one of each two identical graphs in Graph set T and merging each two graphs, in Graph set T, having at least one common floating point into one until there are no such graphs.
   and Step 930 follows.

With reference to FIG. 3, examples show the manner in which Method 900 modifies a plurality of graphic objects in response to a modification of a graphic object or a constraint according to a user's request.

First, suppose that Point 343 had not been yet in Curve 350's node list, but according to a user's request, it was added to the curve's node list and consequently Path 353 was added to the curve's path list. Then, a graph A is created, and Point 351, which is a floating point, adjacent to Point 343, in the Curve 350's node list, Paths 353 and 354, which are incident to Point 351, and Points 343 and 334, respectively, to which Paths 353 and 354 are incident, are added to it. Graph A is modified by resetting Point 351's location and modifying Paths 353 and 354 so that the sum of the lengths of Paths 353 and 354 in terms of Curve 350's map is minimized. Curve 350's attributes are updated. No graphic object is constrained to Point 351 or Curve 350, so that no graphic object is added to the initially empty graphic object queue and the method ends.

Next, suppose that according to a user's request, the location of Point 343 was reset.
Then, a graph B is created, and Point 343, which is Region 370's center, is added to it. Another graph C is created, and Path 346, which is in the Curve 340's path list and incident to Point 343, and Point 343 and 342 are added to it. A yet another graph D is created, and Point 351, Paths 353 and 354, and Points 343 and 334 are added to it. Graph B remains the same as it consists only of a fixed point. Graph C is modified by modifying Path 346 to be shortest in terms of Curve 340's map. Graph D is modified by resetting Point 351's location and modifying Paths 353 and 354 so that the sum of the lengths of the two paths in terms of Curve 350's map is minimized. Region 370 is modified by modifying its tree to a shortest path tree rooted at Point 343 in terms of Region 370's map on condition that no path in the tree is longer than the region's bound, which is set to 100 in Text Box 435 as illustrated in FIG. 4. The attributes of Region's 370 and Curves 340 and 350 are updated. Point 352, which is constrained to Point 343, and Point 351, which is constrained to Region 370, are added to the empty graphic object queue.
Then, Point 352 is removed from the graphic object queue, and a graph E is created, and Point 352, Path 355, and Point 334 are added to it. Graph E is modified by resetting Point 352's location and modifying Path 355 so that Path 355's length in terms of Curve 350's map is minimized. Curve 350's attributes are updated. Curve 320, which is constrained to Point 352, is added to the graphic object queue.
Then, Point 351 is removed from the graphic object queue, and a graph F is created, and Point 351, Paths 353 and 354, and Points 343 and 334 are added to it. Graph F is modified by resetting Point 351's location and modifying Paths 353 and 354 so that the sum of the lengths of Paths 353 and 354 in terms of Curve 350's map is minimized. Curve 350's attributes are updated. No graphic object is constrained to Point 351 or Curve 350, so that no graphic object is added to the graphic object queue.
Then, Curve 320 is removed from the graphic object queue, and a graph G is created, and Point 322, which is a floating point in Curve 320's node list, Paths 324 and 325, which are incident to Point 322, and Points 321 and 323, respectively, to which Paths 324 and 325 are incident, are added. Graph G is modified by resetting Point 322's location and modifying Paths 324 and 325 so that the sum of the lengths of Paths 324 and 325 in terms of Curve 320's map is minimized. Curve 320's attributes are updated. No graphic object is constrained to Point 322 or Curve 320, so that no graphic object is added to the graphic object queue. The graphic object queue is now empty, and the method ends. Note that while Curve 320's length currently equals to the Path 324's length, it eventually must be greater than or equal to the sum of Path 324's length and Path 325's length because Curve 320 is preset to terminate at its sink, which is set to Point 323. Thus, in one embodiment of the present invention, both the current and eventual lengths of each curve may be calculated and presented to the user.

Next, suppose that according to a user's request, Relationship constraint 363's map was reset. Then, Point 333, which is constrained by Relationship constraint 363, is added to the graphic object queue. Then, Point 333 is removed from the graphic object queue, and a graph H is created, Point 333, Paths 336, 337, 344, 345, and 362, which are incident to Point 333, and Points 332, 334, 341, 342, and 361, to which these paths are incident, are added to it. Graph H is modified by resetting Point 333's location and modifying Paths 336, 337, 344, 345, and 362 so that the sum of the lengths of Paths 336, 337, 344, 345, and 362 in terms of the maps of Curve 330, Curve 330, Curve 340, Curve 340, and Region 360, respectively, is minimized. Region 360 is modified by computing a shortest path tree rooted at Point 333 in terms of Region 360's map on condition that no path in the tree is longer than Path 362 and setting Region's 360's tree to the shortest path tree. The attributes of Curves 330 and 340 and Region 360 are updated. No graphic object is constrained to Point 333, Curve 330, Curve 340, or Region 360, so that no graphic object is added to the empty graphic object queue, and the method ends.

Finally, suppose that according to a user's request, Point 333 was deleted, and consequently Point 333 was removed from Curve 330's node list, Paths 336 and 337 were replaced by a new path I (from Point 332 and to Point 334) in Curve 330's path list, Point 333 was removed from Curve 340's node list, Paths 344 and 345 were replaced by a new path J (from Point 341 to Point 342) in Curve 340's path list, and Region 360's center and its curve leaf path were set to null. Then, a graph K is created, and Points 332 and 334, respectively, to which Paths 336 and 337 were, before the deletion of Point 333, incident, and Path I are added to it. Likewise, a graph L is created, and Points 341 and 342 and Path J are added to it. Also, a graph M is created, and Point 361, which is Region 360's leaf, is added to it. Graph K is modified by modifying Path K to be shortest in terms of Curve 330's map. Graph L is modified by modifying Path J to be shortest in terms of Curve 340's map. Graph M is unchanged, as it consists only of a fixed point. As its center is set to null, Region 330's tree is emptied. The attributes of Curves 330 and 340 and Region 360 are updated. No graphic object is constrained to Point 333, Curve 330, Curve 340, or Region 360 so that no graphic object is added to the empty graphic object queue, and the method ends.

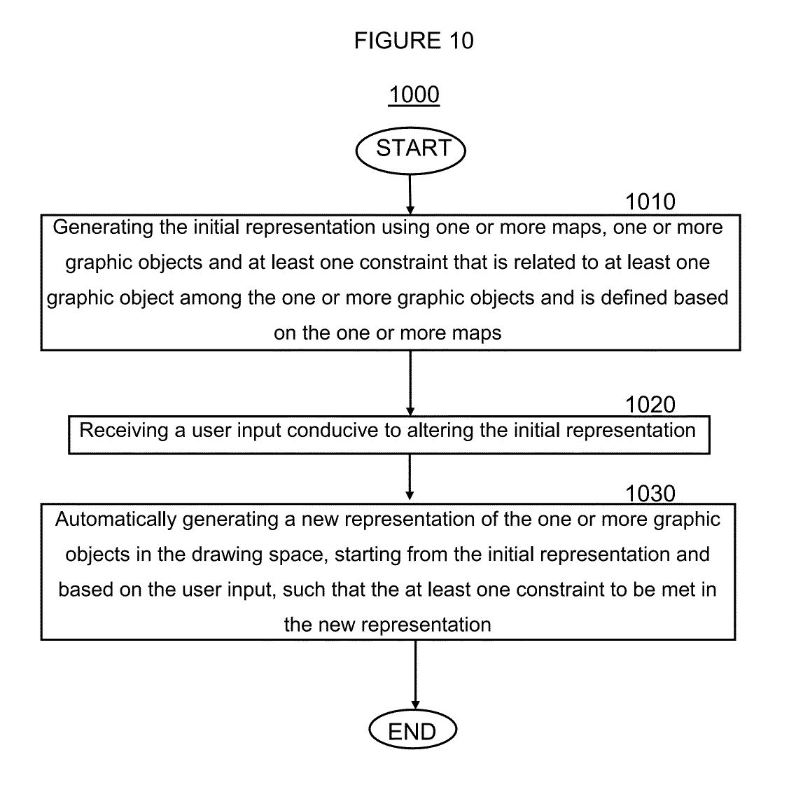

FIG. 10 is a flowchart of a method 1000 for editing an initial representation of graphic objects in a drawing space. Method 1000 includes generating the initial representation at 1010. The initial representation based on
one or more graphic objects located in the drawing space,
one or more maps, in each of which values are assigned to locations in the drawing space, and
at least one constraint that is related to at least one graphic object among the one or more graphic objects and is defined based on the one or more maps.

Method 1000 further includes a user input conducive to altering the initial representation at 1020. Method 1000 also includes at 1030, automatically generating a new representation of the one or more graphic objects in the drawing space, starting from the initial representation and based on the user input, such that the at least one constraint to be met in the new representation.

Method 1000 may include the initial representation and/or the new representation. One or more of the graphic objects may have associated a size determined using a size-related predetermined formula and the values of at least one of the one or more maps. A map-dependent constraint may require a graphic object's size to be within a predetermined range. Another constraint may constraint requires two among the graphic objects to be in a predetermined relationship. Yet another map-dependent constraint may be determined based on a predetermined formula using the values of at least one of the one or more maps. The user input may indicate changes related to a constraint or a graphic object in the drawing space.

When the new representation is generated, some of the graphic objects which are affected by a change required by the user input may be selected and modified. If these modifications lead to one of the constraints to be violated, the change is rejected (i.e., an incompatibility notice may be issued and the new representation coincides with the initial representation).

In one embodiment, plural graphic objects are characterized by sizes determined each using a size-related predetermined formula and the values of at least one of the one or more maps. Automatically generating the new representation may include optimizing at least the size of one of the graphic objects.

The drawing space may be divided into substantially similar cells (e.g., the drawing space is rasterized as illustrated in FIGS. 2A and 2B). A map may be represented by a subset of cells to each of which being associated a value. The graphic object may be a point, a curve and a region having attributes as previously described. If a point, a curve or a region is affected by a change required by the user input, then the corresponding point attributes, curve attributes or region attributes are updated.

In one embodiment, if the user input leads to a graphic object to become subject to more than a predetermined number of cyclic constraints, the change is rejected. In another embodiment, if the user input leads to connecting a number of points that are to be set automatically larger than a predetermined number, the change is rejected.

Method 1000 may further include generating a graphic-object-feasible space associated with one of graphic objects. The graphic-object-feasible space is a subspace in the drawing space determined such that when the graphic object is located inside the graphic-object-feasible space, any constraint related to the graphic object is met. The change of the initial representation may be rejected if the user input leads to an empty graphic-object-feasible space for any of the graphic objects. The change of the initial representation may also be rejected if the user input leads to a null intersection of a region's graphic-object-feasible space with a region's center graphic-object-feasible space and the graphic-object-feasible space of the region's leaf point. Method 1000 may further include rejecting the change of the initial representation if the user input leads to a null intersection of a curve's graphic-object-feasible space with a graphic-object-feasible space of the curve's sink and one or more graphic-object-feasible spaces of the curve's nodes.

Method 1000 may be performed on an apparatus such as apparatus 100 schematically illustrated in FIG. 1. In this case, I/O interface 130 is configured to receive the user input conducive to altering the initial representation. Data processing unit 130 is configured to generate the initial representation and to automatically generate the new representation. I/O interface 130 may include a display configured to display at least one of the initial representation and the new representation. Data storage 110 is configured to store maps, graphic objects and constraints. Data storage 110 may also store executable codes which, when executed on a computer, make the computer perform method 1000.

The disclosed embodiments provide methods and devices for editing an initial representation of graphic objects in a drawing space to automatically generate a new representation of the one or more graphic objects in the drawing space, starting from the initial representation and based on the user input, such that one or more map-dependent constraints to be met in the new representation. It should be understood that this description is not intended to limit the invention. On the contrary, the exemplary embodiments are intended to cover alternatives, modifications and equivalents, which are included in the spirit and scope of the invention as defined by the appended claims. The order of the method steps is merely illustrative and not intended to be limiting; the steps may be performed in an order different from the order in the described embodiments. Further, in the detailed description of exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in particular combinations, each feature or element may be usable alone without the other features and elements of the embodiments or in other various combinations with or without other features and elements disclosed herein.

The written description uses examples of the subject matter disclosed to enable any person skilled in the art to practice the same, including making and using the described devices or systems and performing any of the described methods. The patentable scope of the subject matter is defined by the claims, and may include other examples that occur to those skilled in the art. Such examples are intended to be within the scope of the claims.

What is claimed is:

1. A method for editing an initial representation of graphic objects in a drawing space, the method comprising:
generating the initial representation using
one or more graphic objects located in the drawing space,
one or more maps, in each of which values are assigned to locations in the drawing space, and
at least one constraint that is related to at least one graphic object among the one or more graphic objects and is defined based on the one or more maps;
receiving a user input conducive to altering the initial representation; and
automatically generating a new representation of the one or more graphic objects in the drawing space, starting from the initial representation and based on the user input, such that the at least one constraint to be met in the new representation.

2. The method of claim 1, further comprising:
displaying at least one of the initial representation and the new representation.

3. The method of claim 1, wherein at least one of the one or more graphic objects has associated a size determined using a size-related predetermined formula and the values of at least one of the one or more maps.

4. The method of claim 1, wherein one of the at least one constraint requires a size of the at least one graphic object defined based on one of the one or more maps to be within a predetermined range.

5. The method of claim 1, wherein one among the at least one constraint is determined based on a predetermined formula using the values of at least one of the one or more maps.

6. The method of claim 1, wherein one of the at least one constraint requires at least two among the one or more graphic objects to be in a predetermined relationship.

7. The method of claim 1, wherein
the user input indicates changes related to one of the at least one constraint or one of the one or more graphic objects in the drawing space.

8. The method of claim 1, wherein the automatically generating of the new representation includes:
selecting and modifying a subset of the one or more graphic objects which are affected by a change required by the user input; and
if the selecting and modifying leads to one of the at least one constraint being violated, issuing an incompatibility notice and making the new representation to coincide with the initial representation.

9. The method of claim 1, wherein
some of the one or more graphic objects have sizes determined each using a size-related predetermined formula and the values of at least one of the one or more maps, and
the automatically generating of the new representation includes optimizing of at least one of the sizes.

10. The method of claim 1, wherein
the drawing space is divided into substantially similar cells; and
a map is represented by a subset of cells to each of which being associated a value;

11. The method of claim 10, wherein
the one or more graphic objects have each a graphic object type among a point, a curve and a region,
the point being represented by point attributes including one or more:
a location attribute, which indicates a specific cell where the point is located, and
a state attribute is a logic variable indicating whether a point's location is to be set automatically or manually, respectively,
the curve being represented by curve attributes including one or more:
a node-list attribute which is an ordered set of points through which the curve passes,
a path-list attribute which is an ordered set of paths, each of which passing through an ordered set of cells connecting two consecutive points in the ordered set of points according to the node list attribute,
a sink attribute indicating an end point at which the curve terminates, and
a sink-path attribute that indicates a path between the end point and a last point in the ordered set of points according to the node list attribute;
the region being represented by region attributes including one or more:
a center attribute which indicates a point which is a region's center,
a tree attribute which indicates an acyclic set of paths rooted at the region's center,
a tree-cells attribute which is a set of cells spanned by the acyclic set of paths,
a leaf attribute which indicates a leaf point at which a longest path among the acyclic set of paths terminates, and
a center-leaf-path attribute, which is the longest path.

12. The method of claim 11, wherein, if the graphic object type of a graphic object among the one or more graphic objects that is affected by a change required by the user input is the point, the curve or the region, then the point attributes, the curve attributes or the region attributes corresponding to the affected graphic object, respectively are updated.

13. The method of claim 1, further comprising:
issuing an incompatibility notice and making the new representation to coincide with the initial representation, if the user input leads to one of the one or more graphic objects to become subject to more than a predetermined number of cyclic constraints.

14. The method of claim 1, further comprising:
issuing an incompatibility notice and making the new representation to coincide with the initial representation, if the user input leads to connecting a number of points that are to be set automatically larger than a predetermined number.

15. The method of claim 1, further comprising:
generating a graphic-object-feasible space associated with a graphic object among the one or more graphic objects, the graphic-object-feasible space being a subspace in the drawing space such that any constraint among the at least one constraint that is related to the graphic object and at least one other graphic object is met when the graphic object is located inside the graphic-object-feasible space.

16. The method of claim 15, further comprising:
issuing an incompatibility notice and making the new representation to coincide with the initial representation, if the user input leads to an empty graphic-object-feasible space for at least one of the one or more graphic objects.

17. The method of claim 15, wherein a region, which is one of the one or more graphic objects located in the drawing space, is characterized by a center attribute which indicates a point which is a region's center, a tree attribute which indicates an acyclic set of paths rooted at the region's center, and a leaf attribute which indicates a leaf point at which a longest path among the acyclic set of paths terminates,
the method further comprises issuing an incompatibility notice and making the new representation to coincide with the initial representation, if the user input leads to a null intersection of the graphic-object-feasible space of the region with a first graphic-object-feasible space of the region's center and a second graphic-object-feasible space of the leaf point of the region.

18. The method of claim 15, wherein a curve, which is one of the one or more graphic objects located in the drawing space, is characterized by a node-list attribute which is an ordered set of points through which the curve passes, and a sink attribute indicating an end point at which the curve terminates, and
the method further comprises issuing an incompatibility notice and making the new representation to coincide with the initial representation, if the user input leads to a null intersection of the graphic-object-feasible space of the curve with a first graphic-object-feasible space of the end point and one or more second graphic-object-feasible spaces of the set of points according to the node-list attribute of the curve.

19. An apparatus configured to enable editing an initial representation of graphic objects in a drawing space, the apparatus comprising:
an user interface configured to receive a user input conducive to altering the initial representation; and
a data processing unit configured
to generate the initial representation using
one or more maps, in each of which values are assigned to locations in the drawing space,
one or more graphic objects located in the drawing space, and
at least one constraint that is related to at least one graphic object among the one or more graphic objects and is defined based on the one or more maps, and
to automatically generate a new representation of the one or more graphic objects in the drawing space, starting from the initial representation and based on the user input, such that any constraint among the at least one constraint to be met in the new representation.

20. A computer readable medium non-transitorily storing executable codes which, when executed on a computer, make the computer perform a method comprising:
generating an initial representation of graphic objects in a drawing space using
one or more maps, in each of which values are assigned to locations in the drawing space,
one or more graphic objects located in the drawing space, and
at least one constraint that is related to at least one graphic object among the one or more graphic objects and is defined based on the one or more maps;
receiving a user input conducive to altering the initial representation; and
automatically generating a new representation of the one or more graphic objects in the drawing space, starting from the initial representation and based on the user input, such that any one among the at least one constraint to be met in the new representation.
